(19) United States
(12) Patent Application Publication
(10) Pub. No.: US 2018/0336738 A1
(43) Pub. Date: Nov. 22, 2018

(54) On-Board Vehicle Parking Transaction System

(71) Applicant: Meter Feeder, Inc., Pittsburgh, PA (US)

(72) Inventors: James Gibbs, Pittsburgh, PA (US); Daniel W. Lopretto, Pittsburgh, PA (US)

(21) Appl. No.: 15/983,558

(22) Filed: May 18, 2018

Related U.S. Application Data
(60) Provisional application No. 62/613,914, filed on Jan. 5, 2018.
(60) Provisional application No. 62/509,363, filed on May 22, 2017.

(51) Int. Cl. G07B 15/02; G07C 5/08; G07C 5/00; G06Q 20/12

(52) U.S. Cl. CPC G07B 15/02; G06Q 20/127; G07C 5/008; G07C 5/0841

(57) ABSTRACT

A parking transaction system uses a vehicle on-board diagnostics system and sensors to determine when a vehicle has parked in a designated parking zone. The determination may occur by monitoring engine or motor status sensors, geolocation sensors, and/or other in-vehicle sensors to determine whether the vehicle in an energy-efficient state while in a known parking zone. When the vehicle is parked in a designated parking zone and in an energy-efficient state, the vehicle's system will initiate a parking transaction for a minimum period of time. If the vehicle sensors indicate that the vehicle has not moved out of the energy efficient state and away from the parking zone before the time period ends, the system will automatically extend the parking transaction for one or more additional time periods.

### RELATED APPLICATIONS AND CLAIM OF PRIORITY

This patent document claims priority to: (i) U.S. Provisional Patent Application No. 62/509,363, filed May 22, 2017; and (ii) U.S. Provisional Patent Application No. 62/613,914, filed Jan. 5, 2018. The disclosures of each of the priority applications are fully incorporated into this application by reference.

### BACKGROUND

The operation of vehicle parking facilities can be resource-intensive. Currently, municipalities and other parking system operators employ human operators and/or meters, kiosks and other hardware to collect payment for parking transactions, and to record when vehicles arrive at a parking facility. These systems lead to increased costs and parking resource inefficiencies.

Some operators use mobile electronic applications to accept payments. Such systems significantly increase efficiency. However, such systems still rely on resource-intensive enforcement activities. In addition, they do not always accurately account for time that a vehicle spends in a parking space. This can either increase costs for the vehicle operator or result in lost revenue opportunities for the parking system operator.

When autonomous vehicles are used, the ability to use existing parking transaction systems will become even more challenging, as no human vehicle operator will be available to interact with a parting attendant, or to activate a parking meter, kiosk or mobile parking transaction application.

This document describes methods and systems that are designed to solve some or all of the issues described above.

### SUMMARY

In various embodiments, a parking transaction system uses a vehicle on-board diagnostics system and sensors to determine when a vehicle has parked in a designated parking zone. The determination may occur by monitoring engine or motor status sensors, geolocation sensors, and other in-vehicle sensors to determine whether the vehicle is both in an energy-efficient state and in the designated parking zone. When the vehicle is parked in a designated parking zone, the system will initiate a parking transaction for a minimum period of time. If the vehicle sensors indicate that the vehicle has not moved from the parking zone before the time period ends, the system will automatically extend the parking transaction for one or more additional time periods.

In various embodiments, a vehicle parking transaction management system includes a vehicle that has an on-board diagnostics (OBD) system, a location sensor, and a data logging device that includes a data input configured to receive vehicle operation data from the OBD system and the location sensor. A processor is also part of the vehicle or in an electronic device that is in communication with the OBD system. A computer-readable medium contains programming instructions that are configured to instruct the processor to generate a start parking request when the data logging device receives: (i) data from the OBD system indicating that the vehicle has performed a status change to an energy-efficient state for at least a threshold period of time; and (ii) data from the location sensor indicating that the vehicle is stopped in a designated parking zone. The processor will cause a transmitter to transmit the start parking request to a remote server.

Optionally, the processor may generate an end parking request when the data logging device receives data indicating that the vehicle changed out of the energy-efficient state and moved from the designated parking zone. It will then cause a transmitter to transmit the end parking request to the remote server.

Optionally, if the remote server receives an end parking request from the processor before a designated period of time ends, the remote server may complete the transaction. Otherwise, the remote server may automatically extend the transaction by authorizing the vehicle to park in the designated parking zone for an additional period of time and obtain a payment from a user account that is associated with the vehicle.

Optionally, if the remote server receives an extend parking request from the processor via the wireless communication network before a first period of time associated with the start parking request ends, then in response the remote server may extend the parking transaction by authorizing the vehicle to park in the designated parking zone for an additional period of time and obtain a payment for the additional period of time from a user account that is associated with the vehicle. The remote server also may extend the parking transaction by authorizing the vehicle to park in the designated parking zone for successive additional periods of time and obtaining payments from the user account for the successive additional periods of time until either: (i) the remote server receives an end parking request from the processor; or (ii) the first period of time and each of the additional periods of time together reach a maximum total time limit.

Optionally, the remote server may access a parking zone data set to determine whether the designated parking zone is a known parking zone in the parking zone data set. If so, the remote server may initiate a parking transaction only if the geographic data corresponds to a known parking zone, otherwise not initiate a parking transaction.

In various embodiments, the location sensor may include a global positioning system sensor, a camera and programming instructions configured to perform object detection on digital images captured by the camera, and/or a receiver configured to receive location signals from proximate beacons.

In various embodiments, the change to an energy-efficient state may be that the vehicle's engine or electric motor turns off, or that the vehicle's engine rpm in an idle range for at least a threshold time period.

In various embodiments, the vehicle may be an autonomous vehicle.

In various embodiments, the data logging device may be a component of the OBD system, or it may be a wireless communication device that is communicatively connected to the OBD system.

In various additional embodiments, a vehicle parking transaction management system includes a server that is in electronic communication with a vehicle via a wireless communication network. The server includes a computer-readable medium that stores programming instructions that are configured to cause the server to receive a start parking request from the vehicle via the wireless communication network. The start parking request includes geographic data received from an in-vehicle geolocation sensor and a user identification token. In response to receiving the start parking request, the server will use the geographic data to determine a parking zone for the parking request, use the user identification token to identify a user account, determine a start time for the parking request, and initiate a parking transaction that authorizes the vehicle to park in the parking zone for a first period of time and to obtain a payment for the first period of time from the user account.

Optionally, if the server receives an end parking request from the vehicle via the wireless communication network before the first period of time ends, the server may complete the parking transaction. Otherwise, the server may automatically extend the parking transaction by authorizing the vehicle to park in the parking zone for an additional period of time and obtaining a payment for the additional period of time from the user account.

Optionally, if the server receives an extend parking request from the vehicle via the wireless communication network before the first period of time ends, the server may extend the parking transaction by authorizing the vehicle to park in the parking zone for an additional period of time and obtaining a payment for the additional period of time from the user account.

Optionally, the server may automatically extend the parking transaction by authorizing the vehicle to park in the parking zone for successive additional periods of time and obtaining payments for the successive additional periods of time until either: (i) the server receives an end parking request from the vehicle; or (ii) the first period of time and each of the additional periods of time together reach a maximum total time limit.

Optionally, the start parking request may include a signal indicating that an engine or electric motor of the vehicle has been turned off, a signal indicating that an engine rpm of the vehicle has been in an idle range for at least a threshold time period, or a signal indicating that the vehicle has not moved for at least a threshold time period. When using the geographic data to determine a parking zone and initiate the parking transaction, the system may access a parking zone data set to determine whether the geographic data corresponds to a known ° parking zone in the parking zone data set, and it may initiate the parking transaction only if the geographic data corresponds to a known parking zone, otherwise not initiate the parking transaction.

Optionally, before initiating the parking transaction, the server may transmit a request for confirmation to the vehicle or to a vehicle operator's electronic device. The server may then wait and not initiate the parking transaction until the server receives an affirmative response to the request for confirmation.

### BRIEF DESCRIPTION OF THE DRAWINGS

FIG. 1 illustrates various elements of an on-board vehicle parking transaction system.

FIG. 2 is a flowchart illustrating various actions that an on-board vehicle parking transaction system may take.

FIG. 3 is a flowchart illustrating alternate embodiments of actions that an on-board vehicle parking transaction system may take.

FIG. 4 illustrates example elements that may be included in an electronic device.

### DETAILED DESCRIPTION

In this document: (i) the term “comprising” means “including, but not limited to”; the singular forms “a,” “an,” and “the” include plural references unless the context clearly dictates otherwise; and (iii) unless defined otherwise, all technical and scientific terms used in this document have the same meanings as commonly understood by one of ordinary skill in the art.

A “vehicle” is a machine that is configured to transport one or more passengers and/or cargo from one location to another. Examples of vehicles include automobiles, trucks, vans, motorcycles, aircraft, watercraft, drones and the like. An “autonomous vehicle” is a land-based, airborne or water-based vehicle that includes a robotic transport system, a processor, and programming instructions that are configured to enable the processor to command the robotic transport system to move the vehicle through an environment without the requirement for human steering or other direction. The transport system may be a motor and set of wheels and/or rollers (in case of a land-based vehicle), or propellers and/or propulsion systems (in case of an unmanned aerial vehicle). Examples of autonomous vehicles are disclosed U.S. Pat. Nos. 6,151,539; 5,170,352; 5,229,941; and 9,075,415, the disclosures of which are fully incorporated into this document by reference.

An “electronic device” or a “computing device” refers to a device that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions. Examples of electronic devices include personal computers, servers, mainframes, virtual machines, containers, vehicle on-board diagnostic systems and/or infotainment systems, other vehicle on-board electronic and/or computing systems, gaming systems, televisions, and mobile electronic devices such as smartphones, personal digital assistants, cameras, tablet computers, laptop computers, media players and the like. In a client-server arrangement, the client device and the server are electronic devices, in which the server contains instructions and/or data that the client device accesses via one or more communications links in one or more communications networks. The server may be a single device or a collection of devices that are distributed but via which share processing devices and/or memory are shared. In a virtual machine arrangement, a server may be an electronic device, and each virtual machine or container may also be considered to be an electronic device. In the discussion below, a client device, server device, virtual machine or container may be referred to simply as a “device” for brevity.

In this document, the terms “memory,” “memory device,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices.

An on-board diagnostics (OBD) system is a set of hardware that is communicatively and/or electrically connected to various components of a vehicle to collect status or operational parameter values from those components. An OBD system may be of a type that is compliant with known hardware standards such as OBD-II, although other OBD systems are also within the scope of the invention. The OBD system may include or be connected to a data logging device that includes a data input (such as a multi-pin connector, communication port, or wireless receiver) that is configured to receive vehicle operation data directly or indirectly from the vehicle's components and from a geolocation sensor. The OBD system also may include a processor, a transmitter and a memory with programming instructions. Such an OBD system will be an electronic device, and it will include a transmitter for transmitting commands and/or data to external electronic devices and/or remote servers. In various embodiments, an OBD system may be embedded or integral with the vehicle's other computing system components, or it may be a separate device that is connected to one or more other on-board vehicle systems.

This document will use the term “energy-efficient state” to refer to a state of a vehicle in which the vehicle does not use energy that is typically required to operate the vehicle's drivetrain. The determination of whether a vehicle is in an energy-efficient state may occur in any of several possible ways. For example, the determination may simply be detecting that the vehicle has been switched to an “off” state. Other methods of determining that a vehicle is in an energy-efficient state may include detecting one or more of the following conditions (either on an instantaneous basis or over a set period of time): (i) that the vehicle has consumed no more than a threshold amount of energy; (ii) that the vehicle's motor or engine has consumed no more than a threshold amount of energy; (iii) that the vehicle's engine is in an idle or off state, or is operating at less than a maximum rotations per minute (rpm); (iv) that the vehicle's electronic systems have switched vehicle operation to an energy-saving mode; (v) that the vehicle's gear selector is in a park position or that the vehicle's parking pawl is engaged; (vi) that the vehicle's gear selector is in a neutral position and the vehicle's parking brake has been activated; and/or (vii) that the vehicle's gear selector is not in either the drive or reverse position.

In this document, the term “parking zone” means a physical space that is designated for vehicle parking. Vehicle operators may initiate parking purchase transactions in which they purchase authorization to park their vehicles in the parking zone for a designated period of time.

In this document, the terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices collectively perform a process.

A “location sensor” is a sensor that is configured to detect, record and/or measure a location in an environment in which the sensor is located. Examples of location sensors include: global positioning system (GPS) sensors; cameras together with a processor and programming instructions that can analyze image files and recognize objects (such as signs or buildings) in the image and compare the recognized objects to data set of known objects; and radio frequency identification (RFID) or other near-field and short-range sensors that can detect signals from proximate transmitters (such as beacons) and compare data in the received signals to known location data sets to identify a location that corresponds to the signal.

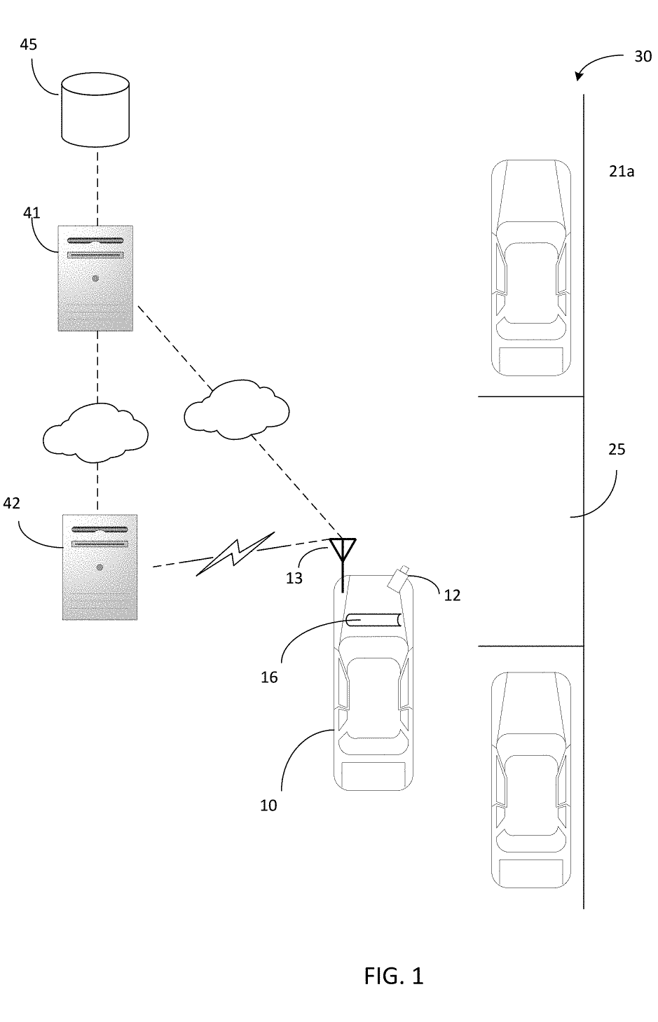

FIG. 1 illustrates an example of a vehicle parking transaction management system in which a vehicle 10 moves throughout an area and is about to enter a parking space 25. The vehicle 10 may be an autonomous vehicle that includes a transport system (such as wheels, an engine or motor, and a drivetrain), a processor and programming instructions that are configured to navigate the vehicle through an environment without the need for a human operator. Alternatively, the vehicle may be one that is configured to be driven by a human operator, or a semi-autonomous vehicle that can be operated by a human and which also has self-driving capabilities. (In the discussion that follows below, and in the claims, references to “autonomous” vehicles are intended to include semi-autonomous vehicles.)

Whether autonomous or human-operated, the vehicle may include one or more proximity sensors and/or cameras 12, a transceiver 13, a global positioning system (GPS) sensor, an OBD system 16 with a data logging device and programming instructions stored on a computer-readable medium. The OBD system is electrically connected to one or more components of the vehicle and receives signals from those components with data relating to the vehicle components' status and/or operational parameters.

For example, the OBD system may receive: (i) data from the vehicle's engine control module (ECM), starter or other components to determine whether the vehicle has been turned on or off; (ii) data from the vehicle's transport system and/or motion sensor(s) to determine whether the vehicle is moving or idle; (iii) GPS data from the vehicle's GPS sensor; (iv) data about the vehicle's environment from proximity sensors and/or cameras; and/or (v) other data. For example, if the OBD system receives data from the ECM indicating that the vehicle engine's rotations per minute (rpm) are zero, the OBD system may determine that the vehicle's engine has been turned off. Alternatively, if the OBD system receives data from the ECM indicating that the vehicle engine's rpm are of a value that is within a known idle speed range, the OBD system may determine that the vehicle is on but idle. For an electric vehicle, the status information may be a motor on/off status indicator, and/or a level of current being drawn by, or voltage across, the motor.

The OBD system also may include or be communicatively connected to a memory with programming instructions that are configured to instruct the processor to generate start parking and end parking requests as will be described below, and to cause the transmitter to transmit the requests to the server.

The vehicle 10 may be an automobile as shown, or it may be any mobile vehicle such as a truck, cart, scooter, unmanned aerial vehicle (UAV) or other mobile device. The transport system will include a motor or engine and a set of wheels and/or rollers (in case of a land-based vehicle), or propellers and/or propulsion systems (in case of a UAV or water-based vehicle).

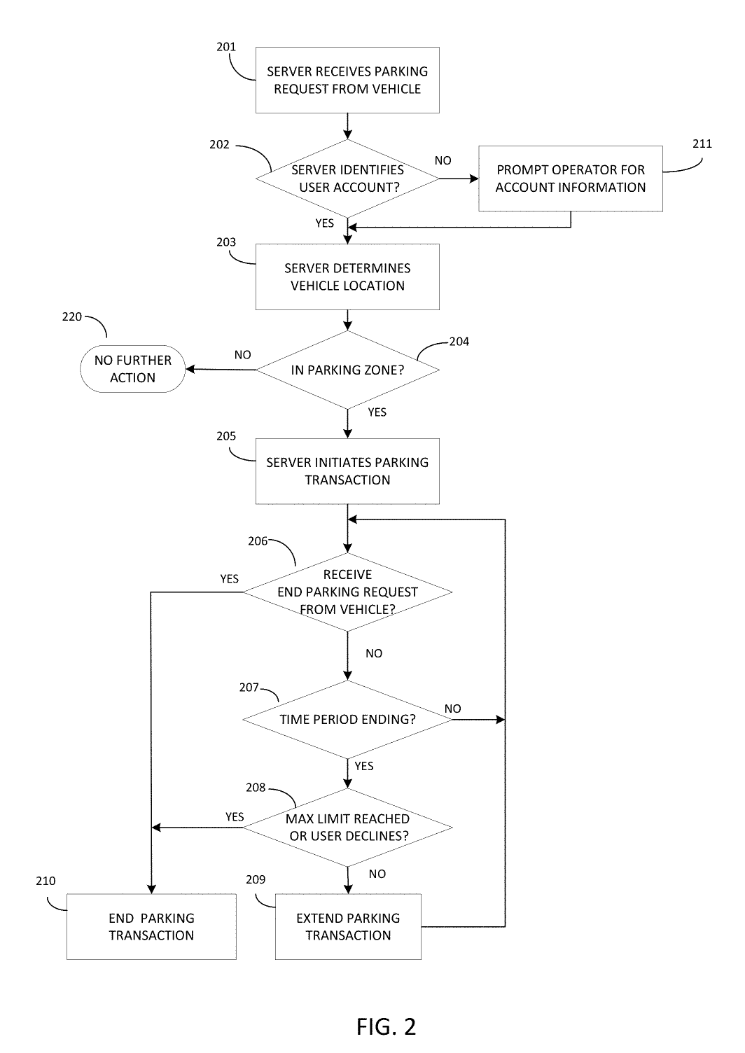

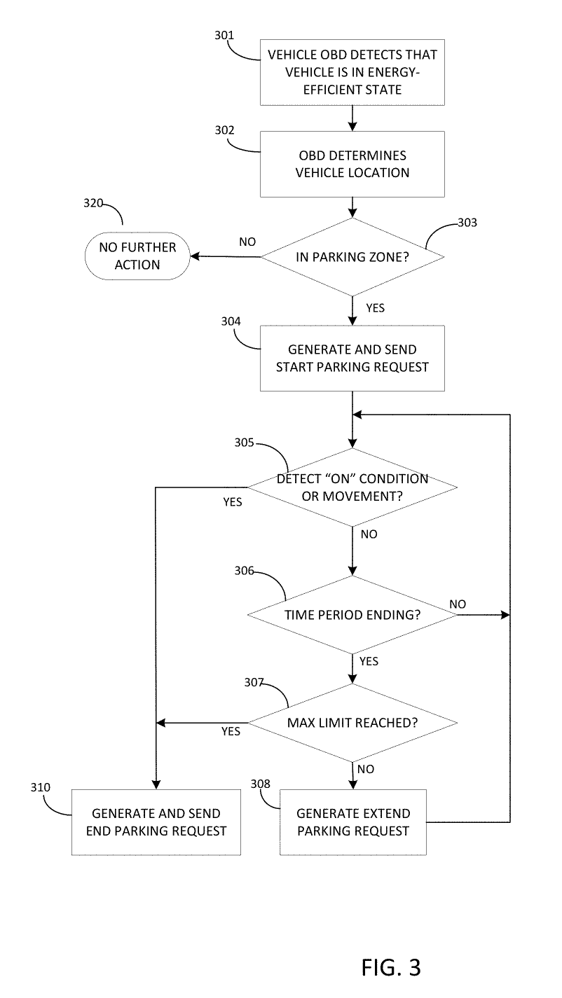

As the vehicle 10 moves throughout an environment, it may encounter one or more parking zones 30 that include one or more available parking spaces 25 in which the vehicle may park. When the vehicle parks in one of the parking spaces, it may send a start parking signal with data via a wireless communication network to a remote server 41 that will use the data to initiate a parking transaction. The signal will alert the server that the vehicle has ended a trip and is thus ready to initiate a parking transaction. The remote server may have access to a data store 45 with account information for the vehicle or vehicle's operator. The remote server 41 also may be, or it may communicate with, a parking system server 42 that can complete the parking transaction by obtaining payment from the vehicle's or operator's account. Additional details about how the system does this will be described below in the context of FIGS. 2 and 3.

Optionally, if the system is an autonomous vehicle, it will include a computer-readable medium with programming instructions that, when executed by a processor of the autonomous vehicle 10, are configured to cause the autonomous vehicle's transport system to move the autonomous vehicle along a route to the parking zone 30 and into the parking space 25.

FIG. 2 illustrates a process by which a vehicle parking transaction system may operate. In the embodiment of FIG. 2, a server receives a signal from a vehicle indicating that the vehicle has completed a trip and thus requests initiation of a parking transaction. The server then initiates and manages a parking transaction for the vehicle until the vehicle begins a new trip. Referring to FIG. 2, the server begins the process by receiving a start parking request from the vehicle (step 201). The start parking request may be a signal that commands the server to initiate a parking transaction, or it may simply be a signal with data that the server can use to determine that that the vehicle has completed a trip. (An example of such a signal is an engine rpm level or motor status indicator. An engine rpm level of zero, a motor off status, a below-threshold motor current draw, a speed of zero for a minimum period of time, or an engine rpm level that is within an idle range and maintained for at least a minimum period of time each may be presumed to be examples of trip completion indicators.) Optionally, the server may require two or more of these data points and/or other data points to be satisfied before it will determine that a signal corresponds to a start parking request. For example, the server may also require that a motion sensor of the vehicle return a signal indicating that the car is not moving. The start parking request may be a signal that originates from an in-vehicle OBD system, or from a mobile electronic device that is in communication with the OBD system such as a smartphone with an installed parking transaction system software application. However, a separate mobile electronic device may not be required if the in-vehicle OBD system can initiate and transmit the start parking request.

In any of these situations, the server also may receive data from the vehicle that includes a user identification token. The user identification token may be a unique identifier that is associated with the vehicle's operator, such as a username or other user identifier. Alternatively, the user identification token may be a unique identifier that is associated with the vehicle, such as a license plate number or vehicle identification number (VIN). (Note: although this discussion uses the term “number” as is convention for the license plate number and VIN, such identifiers may include any string containing a set of numbers, letters or symbols that may serve as a unique identifier.) The server may use the user identification token to identify a user account for the vehicle or the vehicle's operator (step 202). The server may do this by accessing a user account database and identifying an account with which the user identification token is associated. The account may include a payment credential for the user or vehicle, such as a prepaid account number, a credit card number or a customer number that can be used for generation of a bill.

If the server is able to identify a user account with a payment credential, the server will continue with additional steps described below. If the server is not able to identify a user account with a payment credential, it will not initiate a parking transaction. Alternatively and optionally, the server may send a signal to an electronic device (such as mobile electronic device or an in-vehicle electronic device) that will output a prompt that asks a user to enter account information and/or a payment credential (step 211). If the user enters valid account information and/or a valid payment credential in response to the prompt, then the server may proceed as described below.

The server also may receive geographic or other location data from the vehicle. The geographic data will be received from an in-vehicle location sensor, such as a GPS sensor. The server may automatically receive this information from the vehicle with the parking transaction request. Alternatively, the server may send a signal to the vehicle and thus poll the vehicle for this information after the server verifies the user account information. The system may use the geographic data to determine a location for the vehicle (step 203). For example, if the geographic data is GPS coordinates, the server may use the GPS coordinates to determine the vehicle's latitude and longitude. The system may use data from other vehicle proximity sensors as an alternative to the GPS data, or as an additional condition to verify the parking location. Such additional data may be images captured by a vehicle-mounted camera, data collected by a Bluetooth, radio frequency identification (RFID), or other short-range or near-field receiver from a parking system transmitter (such as an RFID tag that is installed in a parking spot), or other data. The system will then access a data set of known parking locations and determine whether the data corresponds to a known parking zone (step 204) and thus the vehicle is in the known parking zone. The server may do this by determine whether the data set includes a parking zone identifier that corresponds to the geographic data.

If the vehicle is in a known parking zone, the server may determine a start time (which may be the time at with the start parking request was received, or the time at which the vehicle operator provided account information, or another suitable time) and initiate a parking transaction for the vehicle (step 205). The parking transaction will authorize the vehicle to park in the parking zone for a first period of time. If the vehicle is not in a known parking zone, the server may take no further action with respect to the parking transaction (step 220) other than to optionally send a signal to the vehicle, the vehicle's operator or another entity indicating that the vehicle is not in a known parking zone and/or that the server cannot complete a parking transaction for the vehicle's current location.

To initiate a parking transaction for the vehicle (step 205), the server will authorize the vehicle to park in the parking zone for a first period of time, and it will obtain payment for the period of time from the user account. The first period of time may be a designated minimum period of time for the parking zone or the user account, or it may be based on some other criteria. Alternatively, the first period of time may be a value that the server receives from the vehicle with the parking transaction request. The payment amount for first period of time will generally be a value that is set by the operator of the parking zone, or that is otherwise known to the system. The server may obtain the payment using the payment credential that is associated with the user account. The server may initiate the parking transaction automatically (without human input) upon detecting that the vehicle has stopped in a known parking zone, or it may transmit a prompt to an electric device that requires the vehicle operator to provide an affirmative response before it will initiate the parking transaction.

When the server receives an end parking request from the vehicle (step 206), then the server will end the parking transaction (step 210). The end parking request may be a signal that serves as a specific command to end the transaction. Alternatively, the end parking request may be a signal that includes information collected by the vehicle's OBD system that the server may use to determine that the vehicle has moved or is about to move from the parking location, such as a signal indicating that the vehicle engine speed (rpm) has moved above an idle speed threshold, or a signal indicated that the vehicle's electric motor has started, or a signal from a vehicle motion sensor indicating that the vehicle has moved,

Optionally, the system may automatically extend the parking transaction (step 209) for one or more incremental periods of time until the server receives an end parking request from the vehicle. The server may extend the parking transaction automatically when the time period has ended or is about to end (i.e., within a threshold time from an ending time) (step 207), at which time it may extend the transaction for an incremental time period (step 209) until an end parking request (step 206) is received. Optionally, the server may send a prompt to an electronic device and wait for the vehicle's operator to affirmatively respond to the prompt before the server will extend the parking transaction.

Optionally, before extending the transaction, the system may determine whether the extension will cause the sum total of all time periods in the transaction to exceed a maximum total time limit threshold. The system also may determine whether the extension will cause the total payment for all time periods in the transactions to exceed a threshold. If any of these conditions exist (step 208), the system may end the parking transaction (step 210) rather than extending it (step 209). In addition, the system also may prompt the user to confirm that the user wishes the system to extend the transaction via a signal to the vehicle or the user's electronic device, and the system may not extend the transaction if the user declines (step 208) the extension within a threshold period of time of the prompt.

In any of the situations described above, the server may process payment for the parking transaction by debiting the user's account, by processing a credit card transaction, by generating an invoice, or otherwise using the payment credential from the user account to secure payment for the parking transaction. The server may process payments incrementally, when the transaction is initiated and upon each extension. Alternatively, the server may process a single payment at the end of the parking transaction, with the payment value being the sum of the payments required for the first time period and each of the periods of extension.

FIG. 3 illustrates additional steps that an on-board vehicle system data logging device may take to manage the parking transaction. The on-board vehicle system and data logging device may be integrated with the vehicle's OBD system. Alternatively or in addition, it may be part of another connected car system such as an in-dash infotainment system. For simplicity, this document may refer to all such on-board vehicle systems that are electrically connected to the vehicle's components as on-board vehicle systems or OBD systems. Alternatively or in addition, it may be part of another system such as a mobile electronic device that is connected to the vehicle or carried by the vehicle's operator and which receives data from the vehicle's OBD via a wireless communication protocol.

After the vehicle has moved into a parking space, the vehicle OBD system will generate a start parking request and cause a transmitter to send it to the parking system server, either directly or through one or more intermediate electronic devices. This and subsequent commands may be generated and transmitted by a processor and transmitter that are integral with the vehicle, or by a mobile electronic device that is within the vehicle and communicatively connected to the vehicle OBD system. In response to receiving the start parking request, the receiving server will initiate a parking transaction with a parking service provider to authorize the vehicle to park in the designated zone for a period of time. The system may do this by using or presenting a payment credential that is associated with the vehicle or its user, selecting a minimum period of time, extending the time as necessary and processing payment with the payment credential for each period incrementally or for the total period of time when the parking transaction ends.

Referring to FIG. 3, the on-board vehicle system's data logging device will generate a start parking request and send the request to a remote server when the system detects that the vehicle has stopped in a designated parking zone. The system may require one or multiple conditions to be satisfied before it will do this. For example, the system may require that vehicle status information indicate that the vehicle has changed state to the vehicle's most energy-efficient state or another level of energy efficiency (such as an energy-efficient state that consumes no more than a threshold amount of energy over a period of time) for at least a minimum period of time (step 301). Examples of information that can provide such an indication include status information indicating that the vehicle's engine or motor is off or in an idle condition for a threshold period of time, such as one minute. The system may do this by requiring, for at least a minimum period of time, an engine rpm level of zero, a motor off status, a below-threshold motor current draw, a speed of zero, or an engine rpm level that is within an idle range and maintained for at least the minimum period of time, or some other condition(s). Optionally, although not necessarily a requirement, the system may also require that a motion sensor of the vehicle return a signal indicating that the car is not moving, or one or more other conditions, before it will generate a start parking request.

The system also may require that it determine that the vehicle's location is in a known parking zone (step 303) before it will generate and send the start parking request. For example, the system may receive geographic data from an in-vehicle location sensor such as a GPS sensor, and it may compare this data to a set of known parking zone locations to determine whether the vehicle is in a known parking zone. The data set may be stored in an in-vehicle memory, or it may be stored on a remote server that the vehicle's system calls via a wireless communication network. The system also may use data from other vehicle proximity sensors as an alternative to the GPS data, or as an additional condition to verify the parking location. Such additional data may be images captured by a vehicle-mounted camera, data collected by a Bluetooth, RFID, or other short-range or near-field receiver from a parking system transmitter (such as an RFID tag that is installed in a parking spot), or other data.

If the vehicle is in a known parking zone, the system may determine a start time and generate and send a start parking request to the remote server (step 304). The start parking request will include an identifier for the vehicle or its operator, as well as the parking zone or a geographic identifier that can be used to identify the parking zone (if not already provided to the server). Optionally, before sending the start parking request to the remote server (step 304), the system may generate a prompt to an operator of the vehicle, and it may output the prompt on an in-vehicle display, an in-vehicle audio output or a user mobile electronic device that asks the user to confirm whether a parking transaction should be initiated. If so, the system may wait and not send the start parking request until it receives confirmation from the user. Also, if the vehicle is not in a known parking zone, the system may take no further action with respect to a parking transaction for the location (step 320) other than to optionally send a signal to the vehicle's operator or another entity, or to output a report via an in-vehicle display or in-vehicle audio output indicating that the vehicle is not in a known parking zone and/or that the system cannot complete a parking transaction for the vehicle's current location.

As with the embodiment of FIG. 2, in the embodiment of FIG. 3 the server will authorize the vehicle to park in the parking zone for a first period of time, and it will obtain payment for the period of time from the user account. The first period of time may be a designated minimum period of time for the parking zone, for the user account, or based on some other criteria. Alternatively, the first period of time may be a value that the server receives from the vehicle with the parking transaction request. The payment amount for first period of time will generally be a value that is set by the operator of the parking zone, or that is otherwise known to the system. The server may obtain the payment using the payment credential that is associated with the user account.

Optionally, the vehicle's on-board system may determine when to send an end parking request to the server. The vehicle may do this by detecting a vehicle on condition (e.g., engine rpm above threshold, motor on, motor current above threshold, etc.) and/or one or more other factors (such as vehicle motion and/or a change in GPS coordinates) (step 305).

The vehicle's on-board system also may determine when to send an extend parking request to the server (step 308). For example, if the current parking transaction period has ended or is about to end (step 306) and a maximum time or payment amount will not be exceeded by the extension (step 307), the vehicle also may send an extended parking request to the server (step 308). Otherwise, it may send an end parking request to the server (step 310). Alternatively, steps 306-308 may occur at the server, which may monitor time periods and automatically authorize extensions in increments until an end parking request is received, or until a maximum time or payment limit is reached without before an end parking request is received.

In any of the situations described above, the server may process payment for the parking transaction by debiting the user's account, by processing a credit card transaction, by generating an invoice, or otherwise using the payment credential from the user account to secure payment for the parking transaction. The server may process payments incrementally, when the transaction is initiated and upon each extension. Alternatively, the server may process a single payment at the end of the parking transaction, with the payment value being the sum of the payments required for the first time period and each of the periods of extension. The server may receive a payment credential with the start parking request, or it may receive a user identification token with the request and use the token to identify an account for the user as with the embodiment of FIG. 2.

In addition, it is intended that other variations of actions taken by the server vs the in-vehicle system may be taken. Some of the steps of FIG. 2 may be done by the in-vehicle system, while some of the steps of FIG. 3 may be done by the remote server. In addition, at some points in time the “in-vehicle” system may include a mobile electronic device that is removed from the vehicle while it is parked. For example, a mobile electronic device may generate a start parking request, and then generate extend parking requests even if it is removed and un-paired with the vehicle's connected car technology, until it is re-paired with the vehicle and it detects that the vehicle is turned on and/or leaving the parking zone.

Thus, in various embodiments the steps listed above may enable the completion of parking transactions without requiring any special payment infrastructure such as parking meters or kiosks. However, in other embodiments the system may use certain infrastructure, such as beacons or tags installed in a parking space, to help it determine when a vehicle is in a designated parking zone.

In any of these embodiments, when the server receives a start parking request from a vehicle with a user identification token and geographic information, it may determine whether the user (i.e., the individual user or the vehicle) is subject to any outstanding parking violations that were assessed by a parking authority. The server may do this by accessing the user's account and determining whether an outstanding violation is noted in the account, or it may access an enforcement database and determine whether the user identification token corresponds to any outstanding violations that are in the enforcement database.

If the user or the vehicle is subject to an outstanding parking violation, then the server may process payment for the violation using the payment credential that is stored in the user's account. The server may take this action automatically, or it may output a prompt to the user and only process the payment if the user affirmatively responds to the prompt, or if the user fails to reply with a valid alternate instruction within a threshold period of time. The server also may automatically assess a parking violation, and obtain payment for the violation, if the vehicle remains in a parking location for more than a maximum permitted period of time (optionally plus a grace period), or if the geographic information indicates that the vehicle has parked in a zone where parking is prohibited.

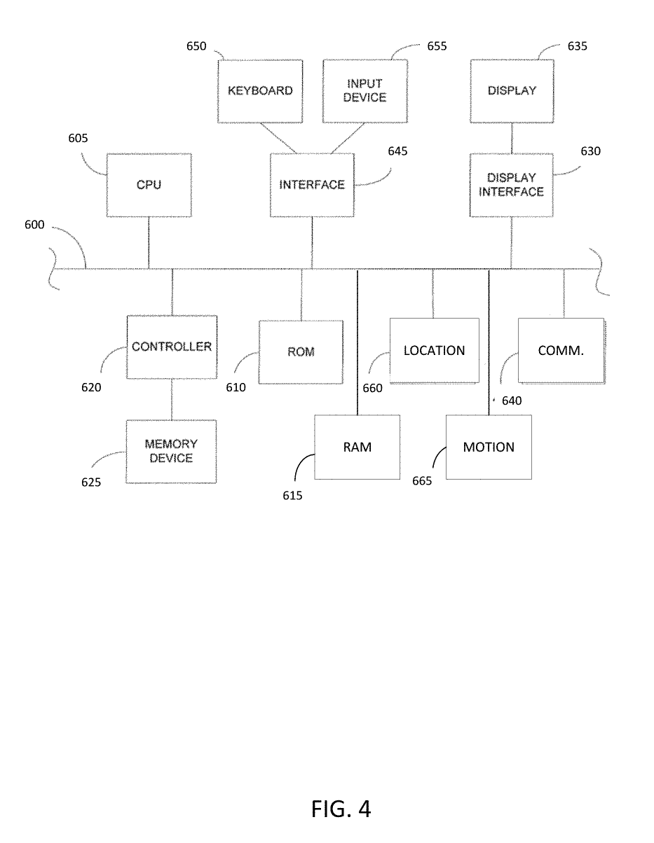

FIG. 4 depicts a block diagram of hardware that may be used to contain or implement program instructions, such as those of any of the cloud-based servers, electronic devices or vehicles described above. A bus 600 serves as an information highway interconnecting the other illustrated components of the hardware. Processor (CPU) 605 is a central processing device of the system, performing calculations and logic operations required to execute a program. CPU 605, alone or in conjunction with one or more of the other elements disclosed in FIG. 4, is an example of a processing device, computing device or processor as such terms are used within this disclosure. The processing device may be a physical processing device, a virtual device contained within another processing device, or a container included within a processing device. Read only memory (ROM) 610 and random access memory (RAM) 615 constitute examples of memory devices.

A controller 620 interfaces with one or more optional non-transitory computer-readable storage media (i.e., memory device 625) to the bus 600. These storage media may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 610 and/or the RAM 615. Optionally, the program instructions may be stored on the storage media 625 discussed above. The programming instructions for various steps of the processes described above and in the claims may be stored in a memory of the autonomous vehicle, on a memory of one or more remote servers that are in electronic communication with the autonomous vehicle, or distributed across memory devices of the autonomous vehicle and one or more remote servers.

An optional display interface 630 may permit information from the bus 600 to be displayed on the display 635 in audio, visual, graphic or alphanumeric format. Communication with external devices, such as a printing device, may occur using various communication elements 640, such as a communication port or antenna. A communication element 640 may be communicatively connected to a communication network, such as the Internet or an intranet.

The hardware may also include an interface 645 which allows for receipt of data from input devices such as a keyboard 650 or other input device 655 such as a mouse, a touch pad, a touch screen, a remote control, a pointing device, a video input device and/or an audio input device. A location sensor 660 and/or motion sensor 665 may be included to detect position and movement of the device. Examples of motion sensors 665 include gyroscopes or accelerometers. Examples of location sensors 660 include geolocation sensors such as a global positioning system (GPS) sensor device that receives positional data from an external GPS network. Other location sensors 660 may include Bluetooth, RFID or other near-field or short-range communication receivers that can detect a signal from a proximate beacon's transmitter so that the system can use correlate the beacon's ID to a known location in a data set of stored beacon locations.

The features and functions described above, as well as alternatives, may be combined into many other different systems or applications. Various alternatives, modifications, variations or improvements may be made by those skilled in the art, each of which is also intended to be encompassed by the disclosed embodiments.

1. A vehicle parking transaction management system, comprising:
a vehicle that comprises:
an on-board diagnostics (OBD) system,
a location sensor,
a data logging device that includes a data input configured to receive vehicle operation data from the OBD system and the location sensor,
a processor; and
a computer-readable medium containing programming instructions that are configured to instruct the processor to:
generate a start parking request when the data logging device receives:
data from the OBD system indicating that the vehicle has performed a status change to an energy-efficient state for at least a threshold period of time, and
data from the location sensor indicating that the vehicle is stopped in a designated parking zone, and
cause a transmitter to transmit the start parking request to a remote server.

2. The system of claim 1, further comprising additional programming instructions that are configured to instruct the processor to:
generate an end parking request when the data logging device receives data indicating that the vehicle changed out of the energy-efficient state and moved from the designated parking zone; and
cause a transmitter to transmit the end parking request to the remote server.

3. The system of claim 1, further comprising the remote server, which includes programming instructions that are configured to instruct the remote server to:
if the remote server receives an end parking request from the processor via before a designated period of time ends, complete a parking transaction that was initiated by the start parking request;
otherwise automatically extend the transaction by authorizing the vehicle to park in the designated parking zone for an additional period of time and obtain a payment from a user account that is associated with the vehicle.

4. The system of claim 1, further comprising the remote server, which includes programming instructions that are configured to instruct the remote server to:
receive an extend parking request from the processor via a wireless communication network before a first period of time associated with the start parking request ends; and
in response to receiving the extend parking request, extend a parking transaction that was initiated by the start parking request by authorizing the vehicle to park in the designated parking zone for an additional period of time and obtain a payment for the additional period of time from a user account that is associated with the vehicle.

5. The system of claim 4, further comprising additional programming instructions that are configured to cause the remote server to extend the parking transaction by authorizing the vehicle to park in the designated parking zone for successive additional periods of time and obtaining payments from the user account for the successive additional periods of time until either:
the remote server receives an end parking request from the processor; or
the first period of time and each of the additional periods of time together reach a maximum total time limit.

6. The system of claim 1, further comprising the remote server, which includes programming instructions that are configured to instruct the remote server to:
access a parking zone data set to determine whether the designated parking zone is a known parking zone in the parking zone data set; and
initiate a parking transaction in response to the start parking request only if the geographic data corresponds to a known parking zone, otherwise not initiate a parking transaction.

7. The system of claim 1, wherein the location sensor comprises:
a global positioning system sensor;
a camera and programming instructions configured to perform object detection on digital images captured by the camera; or
a receiver configured to receive location signals from proximate beacons.

8. The system of claim 1, wherein the change to an energy-efficient state comprises
an engine or electric motor of the vehicle turning off; or
an engine rpm of the vehicle being in an idle range for at least a threshold time period.

9. The system of claim 1, wherein the vehicle is an autonomous vehicle.

10. The system of claim 1, wherein the data logging device comprises:
a component of the OBD system; or
a wireless communication device that is communicatively connected to the OBD system.

11. A method of managing a vehicle parking transaction, the method comprising:
by an on-board diagnostics (OBD) system of a vehicle, monitoring operation of the vehicle to detect when the vehicle has performed a status change to or from an energy-efficient state, wherein the change to an energy-efficient state comprises:
an engine or electric motor of the vehicle turning off, or
an engine rpm of the vehicle being in an idle range for at least a threshold time period;
by a location sensor of the vehicle, collecting location data of the vehicle; and
by a processor:
receiving data from the OBD system of the vehicle,
receiving data from a location sensor of the vehicle,
generating a start parking request transaction when both the OBD system indicates that the vehicle has performed a status change to an energy-efficient state for at least a threshold period of time and the location sensor of the vehicle indicates that the vehicle is stopped in a designated parking zone, and
causing a transmitter to transmit the start parking request to a remote server.

12. The method of claim 11 further comprising, by the processor:
generating an end parking request when both the OBD system indicates that the vehicle has changed out of the energy-efficient state and the location sensor indicates that the vehicle moved from the designated parking zone; and
causing the transmitter to transmit the end parking request to a remote server.

13. The method of claim 11 further comprising, by the remote server:
if the remote server receives an end parking request from the processor via before a designated period of time ends, completing a parking transaction that was associated with the start parking request;
otherwise automatically extending the transaction by authorizing the vehicle to park in the designated parking zone for an additional period of time.

14. The method of claim 11 further comprising, by the remote server:
receiving an extend parking request from the processor via the wireless communication network before a first period of time associated with the start parking request ends; and
in response to receiving the extend parking request, extending a parking transaction that was associated with the start parking request by authorizing the vehicle to park in the designated parking zone for an additional period of time and obtaining a payment for the additional period of time from a user account that is associated with the vehicle.

15. The method of claim 14, further comprising, by the remote server, extending the parking transaction by authorizing the vehicle to park in the designated parking zone for successive additional periods of time and obtaining payments from the user account for the successive additional periods of time until either:
the remote server receives an end parking request from the processor; or
the first period of time and each of the additional periods of time together reach a maximum total time limit.

16. The method of claim 11 further comprising, by the remote server:
accessing a parking zone data set to determine whether the designated parking zone is a known parking zone in the parking zone data set; and
initiating a parking transaction for the start parking request only if the geographic data corresponds to a known parking zone, otherwise not initiate a parking transaction.

17. A vehicle parking transaction management system, comprising:
a server that is in electronic communication with a vehicle via a wireless communication network, the server comprising a computer-readable medium that stores programming instructions that are configured to cause the server to:
receive a start parking request from the vehicle via the wireless communication network, wherein the start parking request includes geographic data received from an in-vehicle geolocation sensor and a user identification token;
in response to receiving the start parking request:
use the geographic data to determine a parking zone for the parking request,
use the user identification token to identify a user account,
determine a start time for the parking request, and
initiate a parking transaction that authorizes the vehicle to park in the parking zone for a first period of time and to obtain a payment for the first period of time from the user account.

18. The system of claim 17, further comprising additional programming instructions that are configured to cause the server to:
if the server receives an end parking request from the vehicle via the wireless communication network before the first period of time ends, complete the parking transaction;
otherwise automatically extend the parking transaction by authorizing the vehicle to park in the parking zone for an additional period of time and obtaining a payment for the additional period of time from the user account.

19. The system of claim 17, further comprising additional programming instructions that are configured to cause the server to:
receive an extend parking request from the vehicle via the wireless communication network before the first period of time ends; and
in response to receiving the extend parking request, extending the parking transaction by authorizing the vehicle to park in the parking zone for an additional period of time and obtaining a payment for the additional period of time from the user account.

20. The system of claim 17, further comprising additional programming instructions that are configured to cause the server to extend the parking transaction by authorizing the vehicle to park in the parking zone for successive additional periods of time and obtaining payments for the successive additional periods of time until either:
the server receives an end parking request from the vehicle; or
the first period of time and each of the additional periods of time together reach a maximum total time limit.

21. The system of claim 17, wherein:
the start parking request comprises:
a signal indicating that an engine or electric motor of the vehicle has been turned off,
a signal indicating that an engine rpm of the vehicle has been in an idle range for at least a threshold time period, or
a signal indicating that the vehicle has not moved for at least a threshold time period; and
the programming instructions that are configured to cause the server to use the geographic data to determine a parking zone and initiate the parking transaction comprise instructions to:
access a parking zone data set to determine whether the geographic data corresponds to a known parking zone in the parking zone data set, and
initiate the parking transaction only if the geographic data corresponds to a known parking zone, otherwise not initiate the parking transaction.

22. The system of claim 17, further comprising additional programming instructions that are configured to cause the server to, before initiating the parking transaction:
transmit a request for confirmation to the vehicle or to a vehicle operator's electronic device; and
wait and not initiate the parking transaction until the server receives an affirmative response to the request for confirmation.
